(19) United States
(12) Patent Application Publication
(10) Pub. No.: US 2023/0216225 A1
(43) Pub. Date: Jul. 6, 2023

(54) CONNECTOR FOR COUPLING A CAPACITOR TO A PRINTED CIRCUIT BOARD ASSEMBLY

(71) Applicant: Micron Technology, Inc., Boise, ID (US)

(72) Inventors: Bradley R. Bitz, Meridian, ID (US); Joao E. Chaves, Middleton, ID (US); Kaleb A. Wilson, Caldwell, ID (US); Mark Tverdy, Boise, ID (US)

(21) Appl. No.: 17/677,011

(22) Filed: Feb. 22, 2022

Related U.S. Application Data
(60) Provisional application No. 63/295,017, filed on Dec. 30, 2021.

(51) Int. Cl. H01R 12/70; H01R 12/52; H01R 12/72; H01R 12/53; H01G 9/26

(52) U.S. Cl. CPC H01R 12/7076; H01G 9/26; H01R 12/52; H01R 12/53; H01R 12/721

(57) ABSTRACT

Apparatuses, systems, and methods for coupling a capacitor to a printed circuit board assembly. One example apparatus can include a number of capacitors and a connector coupled to the number of capacitors, the connector configured to removably couple the number of capacitors to a printed circuit board assembly of a solid state drive.

### PRIORITY INFORMATION

This application claims benefit to U.S. Provisional Application No. 63/295,017, filed Dec. 30, 2021, the contents of which are incorporated herein by reference.

### TECHNICAL FIELD

The present disclosure relates generally to printed circuit board assemblies, and more particularly, to apparatuses and methods for coupling a capacitor to a printed circuit board assembly.

### BACKGROUND

Memory devices are typically provided as internal, semiconductor, integrated circuits in computers or other electronic devices. There are many different types of memory including volatile and non-volatile memory. Volatile memory can require power to maintain its data and includes random-access memory (RAM), dynamic random access memory (DRAM), and synchronous dynamic random access memory (SDRAM), among others. Non-volatile memory can provide persistent data by retaining stored data when not powered and can include NAND flash memory, NOR flash memory, read only memory (ROM), Electrically Erasable Programmable ROM (EEPROM), Erasable Programmable ROM (EPROM), and resistance variable memory such as phase change random access memory (PCRAM), resistive random access memory (RRAM), and magnetoresistive random access memory (MRAM), among others.

A memory device can be included on a printed circuit board assembly (PCBA). In some examples, a number of capacitors can be coupled to a PCBA via soldering.

### BRIEF DESCRIPTION OF THE DRAWINGS

FIG. 1A is a schematic diagram of an apparatus including a number of capacitors coupled to a PCBA via a connector in accordance with a number of embodiments of the present disclosure.

FIG. 1B is a schematic diagram of an apparatus including a number of capacitors coupled to a PCBA via a connector in accordance with a number of embodiments of the present disclosure.

FIG. 2A is a schematic diagram of an apparatus including a number of capacitors coupled to a PCBA via a connector in accordance with a number of embodiments of the present disclosure.

FIG. 2B is a schematic diagram of an apparatus including a number of capacitors coupled to a PCBA via a connector in accordance with a number of embodiments of the present disclosure.

FIG. 3 is a schematic diagram of an apparatus including a number of capacitors coupled to a PCBA via a connector in accordance with a number of embodiments of the present disclosure.

FIG. 4 is a schematic diagram of an apparatus including a number of capacitors coupled to a PCBA via a connector in accordance with a number of embodiments of the present disclosure.

FIG. 5 is a block diagram of a host coupled to a computing device in accordance with a number of embodiments of the present disclosure.

### DETAILED DESCRIPTION

Apparatuses, systems, and methods for coupling a capacitor to a printed circuit board assembly (PCBA) are provided herein. In a number of embodiments of the present disclosure, an apparatus can include a number of capacitors and a connector coupled to the number of capacitors, the connector configured to removably couple the number of capacitors to a PCBA of a solid state drive (SSD).

Capacitors can be coupled to SSDs to provide backup energy in case an SSD has an unexpected loss of power. This backup energy gives the SSD enough power to move data from volatile memory to non-volatile memory to prevent data corruption and/or data loss. The type and number of capacitors coupled to an SSD can depend on a capacity of the SSD. Often, PCBAs include enough capacitor placements for a highest capacity SSD design even on a lower capacity SSD design. For example, a low-capacity SSD may only need one capacitor, however, the PCBA includes capacitor placements for eight capacitors. This can unnecessarily increase the size of the PCBA.

Aluminum Electrolytic (AE) capacitors can be a lower cost form factor. Through hole leaded type capacitors can require custom lead forming, insertion tools, and/or selective soldering machines. A PCBA can be exposed to high temperatures, additional handling, and/or moisture during a soldering process, which can damage the PCBA reducing the functionality and/or reliability of the SSD. Custom lead forming and/or soldering can also increase assembly time and cost.

The apparatuses, systems, and methods disclosed herein implement features and techniques to enable any number, size, type, and/or combination of capacitors to be removably coupled to a PCBA using surface mount processes that do not expose the SSD to high temperatures and/or moisture. In a number of embodiments, the connector can comprise a screw configured to fasten a number of capacitors to the PCBA or a male blade configured to couple to the PCBA via a female hole in the PCBA. In some examples, the connector can connect to the PCBA via a surface mount or the connector can be a card edge connector that connects to the PCBA. These types of connections can be done using automation and can reduce the footprint of the PCBA and allow more flexible PCBA layouts. Using these types of connections can also eliminate manufacturing time limits between reflow cycles that are needed to prevent damage to the PCBA when capacitors are soldered.

Capacitors removably coupled to a PCBA can allow manufacturing capacitors and/or their connectors to be outsourced. It also allows, capacitors coupled to a PCBA to be replaced and/or the number of capacitors coupled to the PCBA to be increased, and/or decreased. For example, if a capacitor fails, the capacitor can be removed and replaced with a different capacitor or if the capacity of the SSD is increased or decreased, the number of capacitors can be increased or decreased.

In the following detailed description of the present disclosure, reference is made to the accompanying drawings that form a part hereof, and in which is shown by way of illustration how a number of embodiments of the disclosure may be practiced. These embodiments are described in sufficient detail to enable those of ordinary skill in the art to practice the embodiments of this disclosure, and it is to be understood that other embodiments may be utilized and that process, electrical, and/or structural changes may be made without departing from the scope of the present disclosure.

As used herein, “a number of something can refer to one or more of such things. For example, a number of memory devices can refer to one or more memory devices. Additionally, designators such as “W”, “X”, “Y”, and “Z”, as used herein, particularly with respect to reference numerals in the drawings, indicates that a number of the particular feature so designated can be included with a number of embodiments of the present disclosure.

The figures herein follow a numbering convention in which the first digit or digits correspond to the drawing figure number and the remaining digits identify an element or component in the drawing. Similar elements or components between different figures may be identified by the use of similar digits. As will be appreciated, elements shown in the various embodiments herein can be added, exchanged, and/or eliminated so as to provide a number of additional embodiments of the present disclosure. In addition, the proportion and the relative scale of the elements provided in the figures are intended to illustrate various embodiments of the present disclosure and are not to be used in a limiting sense.

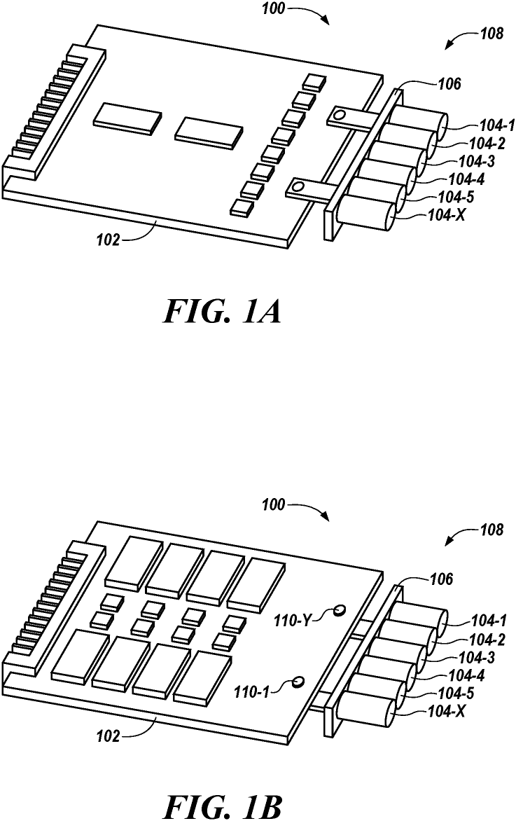

FIGS. 1A and 1B are schematic diagrams of an apparatus 100 including a number of capacitors 104-1, 104-2, 104-3, 104-4, 104-5, and 104-X coupled to a PCBA 102 via a connector 108 in accordance with a number of embodiments of the present disclosure. FIG. 1A is an isometric view of a side of apparatus 100 and FIG. 1B is an isometric view of a different side of apparatus 100.

The apparatus 100 can be a computing system, for example, an SSD. Memory storage devices can be combined together to form an SSD. In a number of embodiments, an SSD can include non-volatile memory (e.g., NAND flash memory, NOR flash memory, and/or wireless memory), and/or can include volatile memory (e.g., DRAM and/or SRAM), among various other types of non-volatile and volatile memory. Flash memory devices can include memory cells storing data in a charge storage structure such as a floating gate or charge trap, for instance, and may be utilized as non-volatile memory for a wide range of electronic applications. Flash memory devices may use a one-transistor memory cell that allows for high memory densities, high reliability, and low power consumption.

Capacitors can be coupled to SSDs to provide backup energy in case an SSD has an unexpected loss of power. The type and number of capacitors coupled to an SSD can depend on a capacity of the SSD.

The capacitors 104-1,..., 104-X illustrated in FIGS. 1A and 1B can be aluminum electrolytic capacitors. Although, the capacitors 104-1,..., 104-X are depicted the same in FIGS. 1A and 1B, the capacitors 104-1,..., 104-X can be different types and/or sizes of capacitors. For example, capacitor 104-1 can be a different type of capacitor than capacitor 104-2. Six capacitors 104-1,..., 104-X are coupled to the PCBA 102 in FIGS. 1A and 1B, however, any number of capacitors can be coupled to the PCBA 102.

Housing and/or shrink-wrap can be used to enclose the number of capacitors 104-1,..., 104-X. Enclosing the capacitors in a housing or shrink-wrap can mechanically fortify the capacitors for shock and/or vibration robustness. Gluing the number of capacitors 104-1,..., 104-X together can also mechanically fortify the capacitors 104-1,..., 104-X for shock and/or vibration robustness. In some examples, the housing and/or shrink-wrap can provide a thermal and/or moisture barrier to protect the capacitors 104-1,..., 104-X from exposure to particular temperatures and/or moisture.

The number of capacitors 104-1,..., 104-X can be coupled to connector 108. In a number of embodiments, the number of capacitors 104-1,..., 104-X can be coupled to the connector 108 mechanically and/or via an adhesive (e.g., glue). However, the number of capacitors 104-1,..., 104-X can also be removably coupled to the connector 108 via a surface mount, for example. Removably coupling the number of capacitors 104-1,..., 104-X to the connector 108 allows the connector 108 and/or one or more of the number of capacitors 104-1,., 104-X to be replaced during manufacturing and/or in the field when the apparatus 100 is in use. For example, a capacitor may be replaced, added, or removed from the connector 108 or the connector 108 may be replaced, added, or removed from the PCBA 102.

The connector 108 can include a printed circuit board (PCB) 106. The PCB 106 can be a single layer PCB, for example a copper layer, which can reduce the cost of the apparatus 100. In some examples, the PCB 106 can include multiple layers. The connector 108 can attach and/or detach the number of capacitors 104-1,..., 104-X to and/or from the PCBA 102. An electrical connection can be maintained between the number of capacitors 104-1,..., 104-X and the PCBA 102 via the connector 108. The connector 108 can couple the number of capacitors 104-1,..., 104-X to the PCBA 102 without bending a lead or trimming a lead of a capacitor. This can reduce the time and cost of manufacturing the apparatus 100.

The connector 108 can be removably coupled to the PCBA 102 for easy replacement. For example, the connector 108 can be removably coupled to the PCBA 102 via a spring pin, a wire, a surface mount, a card edge connector, a rigid-flex connector, an insulation displacement connector, or a number of fasteners (e.g., screws) 110-1,..., 110-Y, as illustrated in FIG. 1B. In a number of embodiments, the connector 108 can be non-removably coupled to the PCBA 102. For example, the connector 108 can be soldered, pad to pad soldered, interference fitted, and/or compression fitted to the PCBA 102. Although, the connector 108 may not be able to be replaced, the connector 108 can be configured to receive a number of removably coupled capacitors 104-1,..., 104-X that can be different sizes and/or types.

The connector 108 can be received by the PCBA 102. The PCBA 102 can include a number of electronic components coupled to a PCB. The PCB included in the PCBA 102 can be a two-layer PCB. In some examples, the number of electronic components can be soldered into position on the PCB.

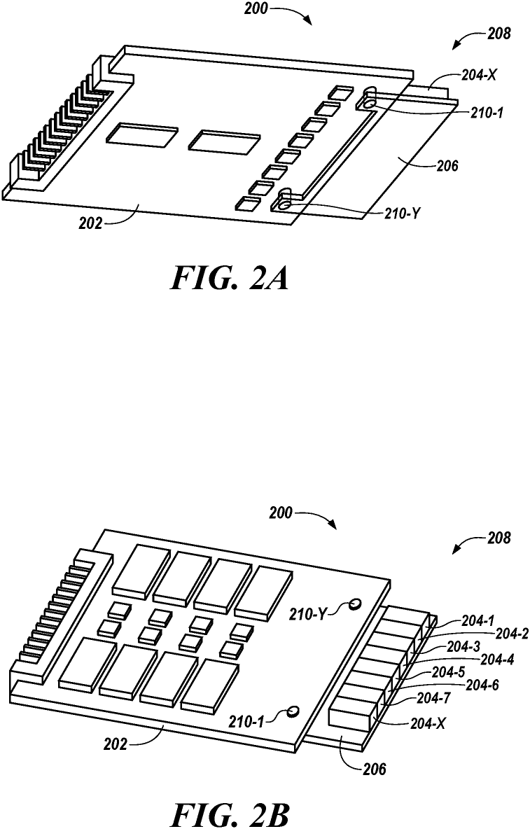

FIGS. 2A and 2B are schematic diagrams of an apparatus 200 including a number of capacitors 204-1, 204-2, 204-3, 204-4, 204-5, 204-6, 204-7, and 204-X coupled to a PCBA 202 via a PCB 206 and a connector 208 in accordance with a number of embodiments of the present disclosure. FIG. 2A is an isometric view of a side of apparatus 200 and FIG. 2B is an isometric view of a different side of apparatus 200. Apparatus 200, the number of capacitors 204-1,..., 204-X, the PCBA 202, the connector 208 and/or the PCB 206 can correspond to apparatus 100, capacitors 104-1,..., 104-X, PCBA 102, connector 108, and/or PCB 106, respectively of FIGS. 1A and 1B.

The apparatus 200 can be a computing system, for example, an SSD. The number of capacitors 204-1,..., 204-X can be coupled to apparatus 200 to provide backup energy in case apparatus 200 has an unexpected loss of power. The type and the number of capacitors 204-1,..., 204-X coupled to the apparatus 200 can depend on the capacity of apparatus 200.

The capacitors 204-1,..., 204-X illustrated in FIGS. 2A and 2B can be Tantalum capacitors. Although, the capacitors 204-1,..., 204-X are depicted the same in FIGS. 2A and 2B, the capacitors 204-1,..., 204-X can be different types and/or sizes of capacitors. For example, capacitor 204-2 can be a different type of capacitor than capacitor 204-3. Eight capacitors 204-1,..., 204-X are coupled to the PCBA 202 in FIGS. 2A and 2B, however, any number of capacitors can be coupled to the PCBA 202.

The number of capacitors 204-1,..., 204-X can be coupled to the connector 208. In a number of embodiments, the number of capacitors 204-1,..., 204-X can be removably coupled to the connector 208. Removably coupling the number of capacitors 204-1,..., 204-X to the connector 208 allows the connector 208 and/or one or more of the number of capacitors 204-1,., 204-X to be replaced, added, or removed from the PCBA 202.

The connector 208 can include the PCB 206. The connector 208 can attach and/or detach the number of capacitors 204-1,..., 204-X to and/or from the PCBA 202. An electrical connection can be maintained between the number of capacitors 204-1,..., 204-X and the PCBA 202 via the connector 208.

The connector 208 can couple the number of capacitors 204-1,..., 204-X via a number of fasteners 210-1,..., 210-Y, as illustrated in FIGS. 2A and 2B. However, the connector 208 is not limited to using fasteners 210-1,..., 210-Y. For example, the connector 208 can couple the number of capacitors 204-1,..., 204-X to the PCBA 202 using a blade, a surface mount, and/or a card edge connector.

The connector 208 can be received by the PCBA 202. The PCBA 202 can include a number of electronic components coupled to a PCB. In some examples, the number of electronic components can be soldered into position on the PCB.

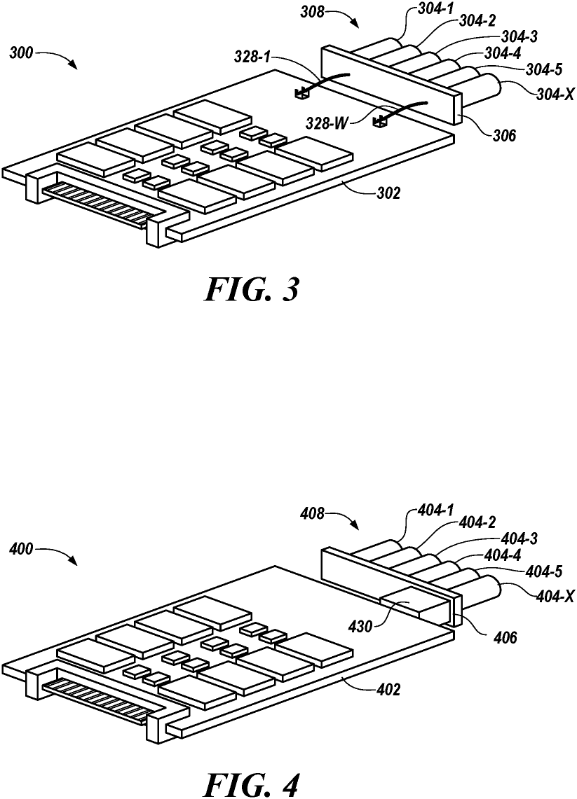

FIG. 3 is a schematic diagram of an apparatus 300 including a number of capacitors 304-1,..., 304-X coupled to a PCBA 302 via a connector 308 in accordance with a number of embodiments of the present disclosure. FIG. 3 is an isometric view of a side of apparatus 300. Apparatus 300, the number of capacitors 304-1,..., 304-X, the PCBA 302, the connector 308 and/or the PCB 306 can correspond to apparatus 100, capacitors 104-1,..., 104-X, PCBA 102, connector 108, and/or PCB 106, respectively of FIGS. 1A and 1B and/or apparatus 200, capacitors 204-1,..., 204-X, PCBA 202, connector 208, and/or PCB 206, respectively of FIGS. 2A and 2B.

The apparatus 300 can be a computing system, for example, an SSD. The number of capacitors 304-1,..., 304-X can be coupled to apparatus 300 to provide backup energy in case apparatus 300 has an unexpected loss of power. The type and the number of capacitors 304-1,..., 304-X coupled to the apparatus 300 can depend on the capacity of apparatus 300.

The capacitors 304-1,..., 304-X illustrated in FIG. 3 can be aluminum electrolytic capacitors. Although, the capacitors 304-1,..., 304-X are depicted the same in FIG. 3, the capacitors 304-1,..., 304-X can be different types and/or sizes of capacitors. For example, capacitor 304-2 can be a different type of capacitor than capacitor 304-3. Six capacitors 304-1,..., 304-X are coupled to the PCBA 302 in FIG. 3, however, any number of capacitors can be coupled to the PCBA 302.

The number of capacitors 304-1,..., 304-X can be coupled to the connector 308. In a number of embodiments, the number of capacitors 304-1,..., 304-X can be removably coupled to the connector 308. Removably coupling the number of capacitors 304-1,..., 304-X to the connector 308 allows the connector 308 and/or one or more of the number of capacitors 304-1,..., 304-X to be replaced, added, or removed from the PCBA 302.

The connector 308 can include the PCB 306. The connector 308 can attach and/or detach the number of capacitors 304-1,..., 304-X to and/or from the PCBA 302. An electrical connection can be maintained between the number of capacitors 304-1,..., 304-X and the PCBA 302 via the connector 308.

The connector 308 can couple the number of capacitors 304-1,..., 304-X via a number of wires 328-1,..., 328-W, as illustrated in FIG. 3. In a number of embodiments, the connector 308 can be an insulation displacement connector. An insulation displacement connector can be connected to a conductor of an insulated cable by forcing a number of selectively sharpened blades through the insultation of the insulated cable without stripping the conductors of insulation before connecting.

The connector 308 can be received by the PCBA 302. The PCBA 302 can include a number of electronic components coupled to a PCB. In some examples, the number of electronic components can be soldered into position on the PCB.

FIG. 4 is a schematic diagram of an apparatus 400 including a number of capacitors 404-1,..., 404-X coupled to a PCBA 402 via a connector 408 in accordance with a number of embodiments of the present disclosure. FIG. 4 is an isometric view of a side of apparatus 400. Apparatus 400, the number of capacitors 404-1,..., 404-X, the PCBA 402, the connector 408 and/or the PCB 406 can correspond to apparatus 100, capacitors 104-1,..., 104-X, PCBA 102, connector 108, and/or PCB 106, respectively of FIGS. 1A and 1B, apparatus 200, capacitors 204-1,..., 204-X, PCBA 202, connector 208, and/or PCB 206, respectively of FIGS. 2A and 2B, and/or apparatus 300, capacitors 304-1,..., 304-X, PCBA 302, connector 308, and/or PCB 306, respectively of FIG. 3.

The apparatus 400 can be a computing system, for example, an SSD. The number of capacitors 404-1,..., 404-X can be coupled to apparatus 400 to provide backup energy in case apparatus 400 has an unexpected loss of power. The type and the number of capacitors 404-1,..., 404-X coupled to the apparatus 400 can depend on the capacity of apparatus 400.

The capacitors 404-1,..., 404-X illustrated in FIG. 4 can be aluminum electrolytic capacitors. Although, the capacitors 404-1,..., 404-X are depicted the same in FIG. 4, the capacitors 404-1,..., 404-X can be different types and/or sizes of capacitors. For example, capacitor 404-2 can be a different type of capacitor than capacitor 404-3. Six capacitors 404-1,..., 404-X are coupled to the PCBA 402 in FIG. 4, however, any number of capacitors can be coupled to the PCBA 402.

The number of capacitors 404-1,..., 404-X can be coupled to the connector 408. In a number of embodiments, the number of capacitors 404-1,..., 404-X can be removably coupled to the connector 408. Removably coupling the number of capacitors 404-1,..., 404-X to the connector 408 allows the connector 408 and/or one or more of the number of capacitors 404-1,..., 404-X to be replaced, added, or removed from the PCBA 402.

The connector 408 can include the PCB 406. The connector 408 can attach and/or detach the number of capacitors 404-1,..., 404-X to and/or from the PCBA 402. An electrical connection can be maintained between the number of capacitors 404-1,..., 404-X and the PCBA 402 via the connector 408.

In a number of embodiments, the connector 408 can couple the number of capacitors 404-1,..., 404-X via a card edge connector 430, as illustrated in FIG. 4. The card edge connector 430 can be a female connector that is attached to an edge of the PCBA 402. The male connector can be formed out of the edge of the PCBA 402.

The connector 408 can be received by the PCBA 402. The PCBA 402 can include a number of electronic components coupled to a PCB. In some examples, the number of electronic components can be soldered into position on the PCB.

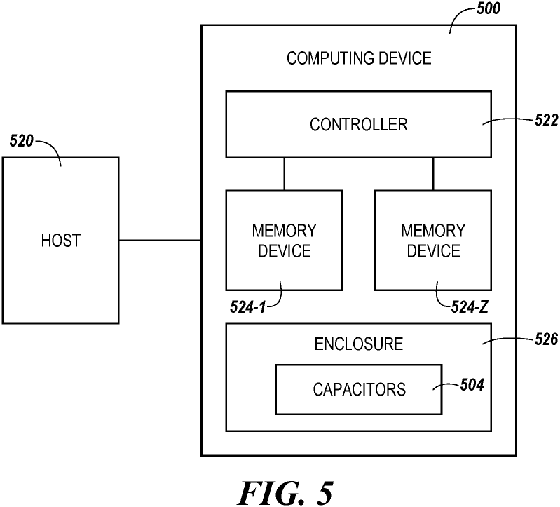

FIG. 5 is a block diagram of a host 520 coupled to a computing device 500 in accordance with a number of embodiments of the present disclosure. The host 520 can provide data to and/or request data from computing system 500.

The computing system 500 can correspond to apparatus 100 of FIGS. 1A and 1B, apparatus 200 of FIGS. 2A and 2B, apparatus 300 of FIG. 3, and/or apparatus 400 of FIG. 4. The computing system 500 can be, for example, an SSD. The computing system 500 can include a controller 522, a number of memory devices 524-1,..., 524-Z, and/or a number of capacitors 504.

The controller 522 (e.g., an SSD controller), such as a processing device, can be coupled to the number of memory devices 524-1,..., 524-Z. The controller 522 can receive a request to store data at the number of memory devices 524-1,..., 524-Z and/or retrieve data from the number of memory devices 524-1,..., 524-Z. The controller 522 can transmit a command to one or more of the number of memory devices 524-1,..., 524-Z to store or retrieve data.

The host 520 can utilize the computing system 500 to store data at a number of memory devices 524-1,..., 524-Z and/or to retrieve data from the number of memory devices 524-1,..., 524-Z. The number of memory devices 524-1,..., 524-Z can include non-volatile memory and/or volatile memory.

The number of capacitors 504 can be coupled to the number of memory devices 524-1,..., 524-Z to provide backup energy in case the computing system 500 has an unexpected loss of power. The number of capacitors 504 can correspond to capacitors 104-1,..., 104-X in FIGS. 1A and 1B, capacitors 204-1,..., 204-X in FIGS. 2A and 2B, capacitors 304-1,..., 304-X in FIG. 3, and/or 404-1,..., 404-X in FIG. 4.

An enclosure 526 can be used to enclose the number of capacitors 504. The enclosure 526 can be plastic or metal housing and/or shrink-wrap. Enclosing the capacitors 504 can mechanically fortify the capacitors for shock and/or vibration robustness. In some examples, the housing and/or shrink-wrap can provide a thermal and/or moisture barrier to protect the capacitors 304 from exposure to particular temperatures and/or moisture.

Although specific embodiments have been illustrated and described herein, those of ordinary skill in the art will appreciate that an arrangement calculated to achieve the same results can be substituted for the specific embodiments shown. This disclosure is intended to cover adaptations or variations of various embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the present disclosure includes other applications in which the above structures and methods are used. Therefore, the scope of various embodiments of the present disclosure should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus, comprising:
a number of capacitors; and
a connector coupled to the number of capacitors, the connector configured to removably couple the number of capacitors to a printed circuit board assembly (PCBA) of a solid state drive (SSD).

2. The apparatus of claim 1, wherein the connector is configured to maintain electrical connection between the number of capacitors and the PCBA.

3. The apparatus of claim 1, wherein the number of capacitors are coupled to the connector mechanically or via an adhesive.

4. The apparatus of claim 1, wherein the connector comprises a printed circuit board (PCB).

5. The apparatus of claim 1, wherein a first capacitor of the number of capacitors is a different type of capacitor than a second capacitor of the number of capacitors.

6. The apparatus of claim 1, wherein the number of capacitors comprise at least one of: an aluminum electrolytic capacitor or a tantalum capacitor.

7. The apparatus of claim 1, wherein the number of capacitors are enclosed in a housing.

8. The apparatus of claim 1, wherein the number of capacitors are enclosed in shrink-wrap.

9. A method, comprising:
removably coupling a number of capacitors to a printed circuit board assembly (PCBA) of a solid state drive (SSD) via a connector; and
maintaining an electrical connection between the number of capacitors and the PCBA.

10. The method of claim 9, comprising detaching the number of capacitors from the PCBA.

11. The method of claim 10, comprising coupling a different number of capacitors to the PCBA via a different connector.

12. The method of claim 10, comprising coupling a different number of capacitors to the PCBA via the connector.

13. The method of claim 9, comprising coupling the number of capacitors to the PCBA without bending a lead of at least one of the number of capacitors.

14. The method of claim 9, comprising coupling the number of capacitors to the PCBA without trimming a lead of at least one of the number of capacitors.

15. A system, comprising:
a printed circuit board assembly (PCBA);
a number of capacitors; and
a connector removably coupled to the number of capacitors, the connector configured to couple the number of capacitors to the PCBA.

16. The system of claim 15, wherein the connector comprises a screw, the screw configured to fasten the number of capacitors to the PCBA.

17. The system of claim 15, wherein the connector comprises a male blade, the male blade configured to couple to the PCBA via a female hole in the PCBA.

18. The system of claim 15, wherein the connector is configured to connect to the PCBA via a surface mount.

19. The system of claim 15, wherein the connector is a card edge connector.

20. The system of claim 15, wherein the connector is an insulation displacement connector connected to the PCBA via a number of wires.
